(19) United States
(12) Patent Application Publication
(10) Pub. No.: US 2008/0242802 A1
(43) Pub. Date: Oct. 2, 2008

(54) Vinyl Chloride Resin Composition

(75) Inventors: Kisaburo Noguchi, Hyogo (JP); Toshihito Kawauchi, Hyogo (JP); Mitsuyoshi Kuwahata, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Kaneka Corporation, Osaka-shi (JP)

(21) Appl. No.: 10/594,586

(22) PCT Filed: Mar. 16, 2005
(86) PCT No.: PCT/JP05/04598

§ 371 Date: Sep. 28, 2006

(30) Foreign Application Priority Data
Mar. 30, 2004 (JP) 2004-099103
Mar. 30, 2004 (JP) 2004-099113
Mar. 30, 2004 (JP) 2004-099121
Mar. 30, 2004 (JP) 2004-099138

(51) Int. Cl. C08F 290/04

(52) U.S. Cl. 525/239

(57) ABSTRACT

Provided are a vinyl chloride resin composition having good melt flowability without lowering the softening temperature and the mechanical strength properties of the molded articles thereof even when various compounding ingredients are not added thereto in a large amount, and a molded article obtained by the composition. The present invention is attained by a vinyl chloride resin composition prepared by adding a vinyl chloride copolymer resin obtained by copolymerizing a vinyl monomer and a macromonomer having a polymer comprising an ethylenically unsaturated monomer containing a double bond in a main chain, to a vinyl chloride resin.

### TECHNICAL FIELD

The present invention relates to a vinyl chloride resin composition and to a molded article using the same. More specifically, the present invention relates to a vinyl chloride resin composition that has good melt flow properties without lowering the softening temperature and the mechanical strength properties of the molded articles thereof, and to a molded article using the same. Further specifically, the present invention relates to a vinyl chloride resin composition useful for obtaining calendar-processed articles having a good surface condition and capable of preventing both air marks and flow marks that may appear on the surfaces of the molded articles formed by calendering a vinyl chloride resin having an average polymerization degree and an average molecular weight that fall within the range generally utilized for calendering, and to a calendar-processed vinyl chloride resin article using the same; to a vinyl chloride resin composition useful for obtaining injection-molded articles having good flowability in molding it without lowering the strength properties of the molded articles formed by injection-molding a vinyl chloride resin having an average polymerization degree and an average molecular weight that fall within the range generally utilized for injection-molding, and to an injection-molded vinyl chloride resin article using the same; and to a hard vinyl chloride resin composition useful for obtaining extrusion-molded articles formed by extrusion-molding a vinyl chloride resin having an average polymerization degree and an average molecular weight that fall within the range generally utilized for extrusion-molding, especially hard extrusion-molded articles such as pipes that are required to have good impact strength and good fracture toughness strength, the latter being a new long-term durability index for high-quality resin articles, and to an extrusion-molded hard vinyl chloride resin article using the same.

### BACKGROUND ART

As having good properties, poly(vinyl chloride) resin is widely used for various molded articles but has various problems in point of its processability, for example, in that its thermal degradation temperature is near to its working temperature and that it could hardly express satisfactory good flowability and mechanical strength properties (e.g., impact-resistant strength, tensile strength, fracture toughness strength). To solve the problems, for example, known are a method of copolymerizing a vinyl chloride type monomer with other monomers, and a method of mixing a plasticizer or any other resin-like substance with poly(vinyl chloride) resin. However, these methods have a drawback in that they could not solve the problems regarding processing with still keeping the excellent physicochemical properties intrinsic to poly(vinyl chloride) resin. For example, when a vinyl chloride type monomer is copolymerized with other monomers or when a plasticizer is added to poly(vinyl chloride) resin, the softening temperature of the obtained molded articles is lowered and the mechanical strength thereof becomes poor. In many of the methods in which any other resin-like substances are mixed, the melt viscosity of the resin mixture is lowered and the apparent processability thereof is thereby improved. However, the mechanical properties and the transparency of the obtained molded articles are poor since the compatibility of the resin-like substances with poly(vinyl chloride) resin is not good.

On the other hand, for improving the impact-resistant strength of vinyl chloride resin as one of the mechanical strength properties thereof, for example, disclosed is a method of adding a methyl methacrylate/butadiene/styrene copolymer (hereinafter abbreviated to MBS resin) or chlorinated polyethylene (hereinafter abbreviated to CPE) as an impact modifier to vinyl chloride resin (Patent Reference 1). However, when such an impact modifier is added to poly(vinyl chloride) resin, then there occur some problems in point of the preparation condition in that the amount of the reinforcing agent to be added must be large for imparting a sufficient mechanical strength to the resin, which cost too much and that the flowability in molding resin could not be improved and, for example, the extruder motor load increases. For promoting the gellation in molding resin without lowering the mechanical properties and the transparency of the poly(vinyl chloride) resin molded articles and for improving the flowability and the secondary processability of resin, for example, there is proposed a method of adding a copolymer comprising, as the main ingredient thereof, methyl methacrylate as a processability improver (Patent Reference 2). According to the method, since the resin gellation may be promoted without lowering the properties of poly(vinyl chloride) resin, molded articles having good transparency and secondary processability and having few air marks may be obtained. However, the method has a fatal drawback in that the surfaces of calendered sheet have flow marks which may deteriorate the commercial value of the articles. For solving the problem of flow marks, for example, there is proposed a method of adding a copolymer comprising, as a main component thereof, a methacrylic ester except methyl methacrylate and having a low polymerization degree, as a processability improver to poly(vinyl chloride) resin (Patent Reference 3). The method may be effective for solving the problem of flow marks but sacrifices the preferred effects that are obtained in the method described in Patent Reference 2 in that the air marks of molded articles can be reduced and the secondary processability thereof can be improved, and as a result, the method also deteriorates the commercial value of the molded articles. These days the market requires high-quality products, and a technique, if possible, capable of reducing air marks of resin articles while preventing flow marks can be an extremely useful industrial technique.

The air marks as referred to herein indicate the traces of air bubbles that have been engulfed by a melted resin during melt-kneading and could not be removed from it, remaining to appear on the surfaces of molded resin articles as spotty or streaky patterns. The flow marks as referred to herein indicate the traces of melted resin gels partly formed between rolls while a melted resin passes through them owing to the change in the resin flow rate or the resin temperature before and after passing though the rolls, remaining to appear on the surfaces of molded resin articles as streaky or striped patterns.

Further, for improving the necessary properties of resin Products without adding and various reinforcing agents and additives in a large quantity thereto, for example, for improving the impact-resistant strength and the fatigue resistance thereof, disclosed is a method of forming hard poly(vinyl chloride) tubes from a resin obtained through graft copolymerization of an acrylic copolymer, which is obtained through conventional ordinary emulsion polymerization, with a vinyl monomer (Patent Reference 4). The reference mentions that the method is effective for improving the impact-resistant strength of the obtained vinyl chloride copolymer resin, but the effect of improving the fracture toughness strength of the resin is still unclear.

Patent Reference 1: JP-A-9-278964
Patent Reference 2: JP-B-53-2898
Patent Reference 3: JP-A-1-247409
Patent Reference 4: JP-A-2003-148660

### DISCLOSURE OF INVENTION

### Problems to be Solved by the Invention

An object of the present invention is to provide a vinyl chloride resin composition that has good melt flow properties without lowering the softening temperature and the mechanical strength properties of the molded articles thereof, and to provide a vinyl chloride resin molded article using the same. Another object of the present invention is to provide a vinyl chloride resin composition that gives calendar-processed articles such as sheets having a good surface condition and capable of preventing both air marks and flow marks, and to provide a calendar-processed vinyl chloride resin article using the same. Still another object of the present invention is to provide a vinyl chloride resin composition for injection-molded articles, which has good flowability in molding without lowering the strength properties of the molded articles even though various additives in a large quantity are not added thereto, and to provide an injection-molded vinyl chloride resin article using the same. Still another object of the present invention is to provide a hard vinyl chloride resin composition for extrusion-molded articles, which can impart high impact strength and high fracture toughness strength to the molded articles even though various reinforcing agents in a large quantity are not added thereto, and to provide an extrusion-molded hard vinyl chloride resin article using the same.

### Means to Solve the Problems

The present inventors have assiduously studied and, as a result, have found that the above-mentioned objects can be attained by using a vinyl chloride resin composition that contains a vinyl chloride copolymer resin obtained through copolymerization of a vinyl monomer and a macromonomer having a polymer comprising an ethylenically unsaturated monomer containing a double bond in a main chain, and have completed the present invention.

Specifically, the present invention relates to the following:

(1) A vinyl chloride resin composition, which is prepared by adding a vinyl chloride copolymer resin obtained by copolymerizing a vinyl monomer and a macromonomer having a polymer comprising an ethylenically unsaturated monomer containing a double bond in a main chain, to a vinyl chloride resin.

(2) The vinyl chloride resin composition, wherein the content of the macromonomer component based on 100 parts by weight of the vinyl chloride resin is 0.1 to 5 parts by weight.

(3) The vinyl chloride resin composition, wherein the macromonomer component in the vinyl chloride copolymer resin is 3 to 50% by weight.

(4) A molded article comprising the vinyl chloride resin composition.

(5) The molded article, which is obtained by calendering.

(6) The molded article, which is obtained by injection-molding.

(7) The molded article, which is obtained by extrusion-molding.

### EFFECT OF THE INVENTION

The vinyl chloride resin composition of the present invention can give good vinyl chloride resin molded articles having good melt flow properties without lowering the softening temperature and the mechanical strength properties of the molded articles thereof. The vinyl chloride resin composition of the present invention gives calendar-processed vinyl chloride resin articles capable of preventing both air marks and flow marks. The vinyl chloride resin composition of the present invention has good flowability during molding and gives injection-molded vinyl chloride resin articles such as joints and valves without lowering the strength properties of the articles. The vinyl chloride resin composition of the present invention gives extrusion-molded hard vinyl chloride resin articles such as pipes having high impact strength and high fracture toughness strength even though various reinforcing agents and additives are not added in a large quantity thereto.

### BEST MODE FOR CARRYING OUT THE INVENTION

The vinyl chloride resin composition of the present invention is characterized to be prepared by adding a vinyl chloride copolymer resin obtained through copolymerization of a vinyl monomer and a macromonomer having a polymer comprising an ethylenically unsaturated monomer containing a double bond in a main chain, to a vinyl chloride resin. Not specifically limited, the composition may be formed into various molded articles in any ordinary molding method known for vinyl chloride resin, for example, calendering, injection-molding, extrusion-molding, blow-molding, pressing, vacuum forming. Falling within the range within which the effect of the present invention is attained, the average degree of polymerization and the average molecular weight of the vinyl chloride resin used in the present invention for such various types of molding are not specifically limited. Similarly to vinyl chloride resin generally prepared and used, the K value of the resin of the present invention, as measured according to JIS K 7367-2, is 50 to 95. Calendering as referred to herein indicates a method of processing a vinyl chloride resin, which comprises putting a resin composition into a hot-rolling device, melt-kneading and rolling it into a sheet and cooling and solidifying it. The vinyl chloride resin used preferably has an average degree of polymerization, as a K value measured according to JIS K 7367-2, of from 58 to 68. Injection-molding also as referred to herein indicates a method of working a vinyl chloride resin, which comprises feeding a resin composition into a hot cylinder by a screw, heating and melting the composition owing to the cylinder heat and the screw shear force thereby to fluidize it, then injecting the resulting melted resin composition into a mold, and cooling and solidifying it to give a molded article. The vinyl chloride resin used preferably has an average degree of polymerization, as a K value measured according to JIS K 7367-2, of from 55 to 61. Extrusion-molding also as referred to herein indicates a method of processing a vinyl chloride resin, which comprises feeding a resin composition into a hot cylinder by a screw, heating and melting the composition owing to the cylinder heat and the screw shear force thereby to fluidize it, then leading the resulting melt through the die disposed at the tip of the cylinder thereby to be molded it, and cooling and solidifying it with water or the like into a molded article. The vinyl chloride resin used preferably has an average degree of polymerization, as a K value measured according to JIS K 7367-2, of from 60 to 73. In any of these molding methods, the mean particle size of the resin is not specifically limited and may be generally from 50 to 300 μm.

“Adding a vinyl chloride copolymer resin to a vinyl chloride resin” means that both the two resins are mixed after prepared through polymerization, and the method for it is not specifically limited so far as it attains the effect of the present invention. For example, it includes a method of mixing latex-type and/or slurry-type polymers; a method of mixing powdery polymers obtained by drying latex-type and/or slurry-type polymers; and a method of mixing a latex-type or slurry-type polymer and a powdery polymer.

Not specifically limited, the vinyl monomer constituting the vinyl chloride copolymer resin for use in the present invention includes, for example, vinyl chloride monomer, vinylidene chloride monomer, vinyl acetate monomer and their mixtures, as well as mixtures of any of them with a monomer copolymerizable therewith and preferably not giving a reactive functional group to the main chain of the resulting polymer, for example, one or at least two kinds selected from α-olefins such as ethylene and propylene. When a mixture of at least two kinds of monomers is used, then the vinyl chloride monomer content therein is preferably at least 50% by weight, more preferably at least 70% by weight of all the vinyl monomers therein. Especially in view of the properties of the copolymer resin to be obtained, at least any one of vinyl chloride monomer or vinylidene chloride monomer alone is preferably used, and more preferably vinyl monomer chloride is used.

A macromonomer is generally an oligomer having a reactive functional group at the terminal of a polymer. The macromonomer for use in the present invention, which has a polymer comprising an ethylenically unsaturated monomer containing a double bond in a main chain, is produced through radical polymerization, and has at least one, per one molecule thereof, of a group having a polymerizable carbon-carbon double bond selected from an allyl group, a vinylsilyl group, a vinyl ether group, a dicyclopentadienyl group and the following general formula (1), at the terminal of the molecule thereof. In particular, the group having a polymerizable carbon-carbon double bond is preferably represented by the following general formula:

—OC(O)C(R)═CH₂ (1),

as its reactivity with a vinyl monomer is good.

In the formula, concrete examples of R are not specifically limited. For example, R is preferably selected from —H, —CH₃, —CH₂CH₃, —(CH₂)ₙCH₃ (where n indicates an integer of from 2 to 19), —C₆H₅, —CH₂OH and —CN; and more preferably, it may be —H or —CH₃.

The polymer comprising an ethylenically unsaturated monomer containing a double bond, which is the main chain of the macromonomer for use in the present invention, is produced by radical polymerization Radical polymerization is grouped into “General Radical Polymerization Method” for simply copolymerizing a monomer having a specific functional group and a vinyl monomer by the use of an azo-type compound or a peroxide that serves as a polymerization initiator; and “Controlled Radical Polymerization Method” that enables introduction of a specific functional group into a controlled site such as the terminal of the polymer produced.

In “General Radical Polymerization Method”, a monomer having a specific functional group is introduced only stochastically into a polymer, so that this monomer needs to be used in a considerably large amount, in case of obtaining a polymer having a high functionalization rate. Molecular weight distribution is so wide that it is difficult to obtain a polymer having low viscosity since the general polymerization process is free-radical polymerization.

“Controlled Radical Polymerization Method” can be further classified into “Chain Transfer Agent Method”, in which a vinyl polymer having a functional group at the end is obtained by polymerizing with the use of a chain transfer agent having a specific functional group, and “Living Radical Polymerization Method”, in which a polymer having a molecular weight approximately designed is obtained by growing a polymerization growth end without causing a termination reaction etc.

In “Chain Transfer Agent Method”, a polymer having a high functionalization rate can be obtained; however, a chain transfer agent having a specific functional group is required for an initiator. Molecular-weight distribution is so wide that it is difficult to obtain a polymer having low viscosity since “Chain Transfer Agent Method” is free-radical polymerization in the same manner as the above-mentioned “General Radical Polymerization Method”.

Unlike these polymerization processes, as described in International Publication No. WO 99/65963 relating to the invention of the applicant oneself of the present invention, even though “Living Radical Polymerization Method” is radical polymerization, which is difficult to control since a polymerization speed is high and a termination reaction due to coupling of radicals each other etc is easily caused, a polymer, in which a termination reaction hardly occurs and molecular-weight distribution is narrow, for example, the ratio of weight-average molecular weight Mw to number average molecular weight Mn (Mw/Mn) is approximately 1.1 to 1.5, can be obtained, and additionally, a molecular weight can to be freely controlled depending on a charge ratio of a monomer to an initiator

Accordingly, “Living Radical Polymerization Method” is a more preferable polymerization process as a preparation process of a vinyl polymer having a specific functional group as described above in the present invention since a monomer having a specific functional group can be introduced to almost any position of a polymer, besides a polymer having narrow molecular weight distribution and low viscosity can be obtained.

Among “Living Radical Polymerization Methods”, “Atom Transfer Radical Polymerization: ATRP”, in which a vinyl monomer is polymerized by using organic halide or a halogenated sulfonyl compound as an initiator, and a transition metal complex as a catalyst is further more preferable as a preparation process of a vinyl polymer having a specific functional group in viewpoints of having halogen and the like, which is comparatively favorable for a functional group transformation reaction, at the end, and a degree of freedom of designing an initiator and a catalyst, in addition to the above-mentioned features of “Living Radical Polymerization Method”. Examples of this Atom Transfer Radical Polymerization is described in Matyjaszewski et al., Journal of American Chemical Society, 1995, Vol. 117, page 5614.

It is not particularly limited which process of those is used as a preparation process of a macromonomer composing a vinyl chloride copolymer resin used in the present invention; Controlled Radical Polymerization Method is generally utilized, and Living Radical Polymerization Method is preferably used in view of easiness of control, and in particular, Atom Transfer Radical Polymerization is the most preferable.

A polymer comprising an ethylenically unsaturated monomer containing a double bond in a main chain of a macromonomer composing a vinyl chloride copolymer resin used in the present invention is not particularly limited, and various kinds can be used as an ethylenically unsaturated monomer containing a double bond composing the polymer. Examples are (meth)acrylic acid monomers such as (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluoyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, ethyleneoxide adducts of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate and 2-perfluorohexadecylethyl (meth)acrylate; styrene monomers such as styrene, vinyltoluene, α-methyl styrene, chlorstyrene, styrenesulfonic acid and salt thereof; fluorine-containing vinyl monomers such as perfluoroethylene, perfluoropropylene and vinylidene fluoride; silicon-containing vinyl monomers such as vinyltrimethoxysilane and vinyltriethoxysilane; maleic anhydride, maleic acid, monoalkyl ester and dialkyl ester of maleic acid; fumaric acid, monoalkyl ester and dialkyl ester of fumaric acid; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide and cyclohexylmaleimide; nitrile group-containing vinyl monomers such as acrylonitrile and methacrylonitrile; amide group-containing vinyl monomers such as acrylamide and methacrylamide; vinyl esters such as vinyl acetate, vinyl propionate, vinyl pivalate, vinyl benzoate and vinyl cinnamate; alkenes such as ethylene and propylene; conjugated dienes such as butadiene and isoprene; allyl chloride, and allyl alcohol. These may be used alone or in copolymerization of at least two kinds. Among those, in view of physical properties of a product, styrene monomers or (meth)acrylic acid monomers are preferable. Acrylic acid ester monomers or methacrylic acid ester monomers are more preferable, acrylic acid ester monomers are further more preferable, and butyl acrylate is most preferable. A copolymer of these preferable monomers and other monomers may be used in the present invention, in which these preferable monomers are preferably contained therein by at least 40% at a weight ratio. Herein, “(meth)acrylic acid” refers to acrylic acid or methacrylic acid.

The macromonomer composing a vinyl chloride copolymer resin used in the present invention is characterized in having a polymer comprising these ethylenically unsaturated monomers containing a double bond in a main chain, and additionally having at least one reactive functional group at a molecular end, per one molecule.

In addition, a macromonomer copolymerizable with a vinyl monomer, composing a vinyl chloride copolymer resin used in the present invention, may be used in only one kind, or macromonomers having different composing ethylenically unsaturated monomers may be used together in at least two kinds.

The partial content of the macromonomer component that has a polymer comprising an ethylenically unsaturated monomer containing a double bond in a main chain, relative to the entire vinyl chloride copolymer resin that is used in the present invention is not specifically limited so far as it falls within a range within which the effect of the present invention can be attained, but is preferably from 3 to 50% by weight. When the partial content of the macromonomer component that has a polymer comprising an ethylenically unsaturated monomer containing a double bond in a main chain is from 3 to 50% by weight, the copolymerization reaction is stable and, in addition, the obtained vinyl chloride copolymer resin can be powdery and can be easy to handle, as well as the latitude in processing the resin is expected to increase. Moreover, when the resulting vinyl chloride copolymer resin is used, then a vinyl chloride resin composition having good melt flow properties can be obtained without lowering the softening temperature and the mechanical strength properties of the resin molded articles. In particular, when the vinyl chloride copolymer resin composition of the present invention is formed into molded articles by molding methods of calendering, injection molding or hard extrusion molding, the partial content of the macromonomer component relative to the entire vinyl chloride copolymer resin to be used is not specifically limited so far as it falls within a range within which the effect of the present invention can be attained, but is preferably from 5 to 50% by weight. When the partial content of the macromonomer component is from 5 to 50% by weight, then the resulting vinyl chloride copolymer resin may give calendar-processed vinyl chloride resin articles that prevent both air marks and flow marks, it may have good flowability during shaping and may give injection-molded vinyl chloride resin articles such as joints and valves without lowering the strength properties of the articles, and it may give extrusion-molded hard vinyl chloride resin articles such as pipes having high impact strength and high fracture toughness strength even though various reinforcing agents and additives are not added in a large quantity thereto.

Falling within the range within which the effect of the present invention is attained, the average degree of polymerization and the average molecular weight of the vinyl chloride copolymer resin for use in the present invention are not specifically limited. Like that of vinyl chloride resin generally produced and used, the K value of the resin of the present invention, as measured according to JIS K 7367-2, is from 50 to 95. The mean particle size of the resin is not also specifically limited, but may be generally from 0.01 to 500 μm, Preferably from 0.1 to 300 μm, more preferably from 50 to 300 μm. When the mean particle size thereof is from 50 to 300 μm, then the resin may provide materials that are well balanced in point of the necessary quality and properties.

In the present invention, a vinyl chloride copolymer resin obtained through copolymerization of a vinyl monomer and a macromonomer having a polymer comprising an ethylenically unsaturated monomer containing a double bond in a main chain, is added to a vinyl chloride resin. The content of the macromonomer component in the vinyl chloride copolymer resin is not specifically limited so far as it falls within a range within which the effect of the present invention can be attained. Preferably, however, the vinyl chloride copolymer resin is added to a vinyl chloride resin in such a ratio that the macromonomer component content therein may be from 0.1 to 5 parts by weight based on 100 parts by weight of the vinyl Chloride resin. When the content of the macromonomer component in the vinyl chloride copolymer resin is from 0.1 to 5 parts by weight based on 100 parts by weight of the vinyl chloride resin, then the resin may provide materials that are well balanced in point of the necessary quality and properties. In particular, when the vinyl chloride copolymer resin of the present invention is applied to injection-molding, the content of the macromonomer component in the vinyl chloride copolymer resin is not specifically limited so far as it falls within a range within which the effect of the present invention can be attained. Preferably, however, the vinyl chloride copolymer resin is added to a vinyl chloride resin in such a ratio that the macromonomer component content therein may be from 0.1 to 1 part by weight based on 100 parts by weight of the vinyl chloride resin. When the content of the macromonomer component in the vinyl chloride copolymer resin is from 0.1 to 1 part by weight based on 100 parts by weight of the vinyl chloride resin, the resin may provide materials that are well balanced in point of the resin flowability during molding and the strength properties of the molded articles.

There is no specific limitation on the method for producing the vinyl chloride copolymer resin for use in the present invention. For the method, copolymerization in an aqueous medium is preferred from the viewpoint of easiness of polymerization control. For example, it includes suspension polymerization, microsuspension polymerization and emulsion polymerization. In particular, preferred is suspension polymerization for obtaining a vinyl chloride copolymer resin having a mean particle size of from 50 to 300 μm. According to the method, the vinyl chloride copolymer resin may be obtained in the form of latex or slurry. There is no specific limitation on the method of drying it to obtain a powdery vinyl chloride copolymer resin. For example, herein employable are a method of drying a resin latex by spraying; a method of drying a resin slurry according to a fluidized drying process after it has been dewatered; and a method of drying a resin slurry according to a ventilation drying process after it has been dewatered.

In the present invention, a vinyl chloride copolymer resin obtained through copolymerization of a vinyl monomer and a macromonomer having a polymer comprising an ethylenically unsaturated monomer containing a double bond in a main chain, is added to a vinyl chloride resin. The monomer constituting the vinyl chloride resin comprises a vinyl chloride monomer as the main component thereof. Concretely, it is a vinyl chloride monomer alone, or a mixture of a vinyl chloride monomer and a monomer copolymerizable with a vinyl chloride monomer and preferably giving no reactive functional group to the main chain of the polymer produced through its polymerization, and the vinyl chloride monomer in the mixture is at least 50% by weight, preferably at least 70% by weight. The monomer copolymerizable with a vinyl chloride monomer includes, for example, vinyl esters such as vinyl acetate, vinyl propionate; α-olefins such as ethylene, propylene, isobutyl vinyl ether; chloro-olefins such as 1-chloropropylene, 2-chlorobutylene; (meth)acrylic esters such as methyl (meth)acrylate; maleic anhydride, acrylonitrile, styrene, vinylidene chloride. These may be used alone or at least two kinds can be used as combined.

There is no specific limitation on the method for producing the vinyl chloride resin for use in the present invention. For the method, polymerization in an aqueous medium is preferred from the viewpoint of easiness of polymerization control. For example, it includes suspension polymerization, microsuspension polymerization and emulsion polymerization. In particular, preferred is suspension polymerization similar to vinyl chloride resins molded by general methods of, for example, calendering, extrusion-molding, injection-molding, blow-molding, pressing or vacuum forming. According to the method, the vinyl chloride resin may be obtained in the form of latex or slurry. There is no specific limitation on the method of drying it to obtain a powdery vinyl chloride resin. For example, herein employable are a method of drying a resin latex by spraying it; a method of drying a resin slurry according to a fluidized drying process after it has been dewatered; and a method of drying a resin slurry according to a ventilation drying process after it has been dewatered.

The content of the macromonomer component which has a polymer comprising an ethylenically unsaturated monomer containing a double bond in a main chain and which constitutes the vinyl chloride copolymer resin, based on 100 parts by weight of the vinyl chloride resin, may be calculated according to the following formula (2):

Z=X×Y÷100 (2)

wherein Z indicates the content of the macromonomer component which has a polymer comprising an ethylenically unsaturated monomer containing a double bond in a main chain and which constitutes the vinyl chloride copolymer resin, based on 100 parts by weight of the vinyl chloride resin (part by weight);
X indicates the partial content of the macromonomer component, which has a polymer comprising an ethylenically unsaturated monomer containing a double bond in a main chain, relative to the vinyl chloride copolymer resin (% by weight); and
Y indicates the amount of the vinyl chloride copolymer resin added to 100 parts by weight of the vinyl chloride resin (part by weight).

The vinyl chloride resin composition of the present invention comprises, as the essential components thereof, a vinyl chloride resin, and a vinyl chloride copolymer resin obtained through copolymerization of a vinyl monomer and a macromonomer having a polymer comprising an ethylenically unsaturated monomer containing a double bond in a main chain, and may optionally contain a thermal stabilizer, a lubricant, a stabilization promoter, a processing aid, a filler, an antioxidant, a light stabilizer, a pigment, a plasticizer and the like so long as not deteriorating the object of the present invention.

The thermal stabilizer is not specifically limited, and any one not deteriorating the object of the present invention may be employed herein. It includes, for example, organic tin thermal stabilizers such as dimethyltin mercaptide, dibutyltin mercaptide, dioctyltin mercaptide, dibutyltin maleate, dibutyltin maleate polymer, dioctyltin maleate, dioctyltin maleate polymer, dibutyltin laurate, dibutyltin laurate polymer; lead-based thermal stabilizers such as lead stearate, dibasic lead phosphite, tribasic lead sulfate; calcium-zinc thermal stabilizers; barium-zinc thermal stabilizers; cadmium-barium thermal stabilizers. These may be used alone or at least two kinds can be used as combined. The amount of the stabilizer to be used is not specifically limited, and may be the range not deteriorating the object of the present invention. If used, however, the amount of the thermal stabilizer is preferably at most 5 parts by weight relative to 100 parts by weight of the vinyl chloride resin.

The lubricant is not also specifically limited, and any one not deteriorating the object of the present invention may be employed herein. It includes, for example, paraffin wax lubricants, polyolefin wax lubricants, stearic acid lubricants, alcohol-type lubricants, and ester-type lubricants. One or more of these may be used herein either singly or as combined. The amount of the lubricant to be used is not also specifically limited and may be the range not deteriorating the object of the present invention. If used, however, the amount of the lubricant is preferably at most 3 parts by weight relative to 100 parts by weight of the vinyl chloride resin.

The stabilization aid is not also specifically limited, and any one not deteriorating the object of the present invention may be employed herein. It includes, for example, epoxidized soybean oil, epoxidized linseed oil, epoxidized tetrahydrophthalate, epoxidized polybutadiene, and phosphoric ester. These may be used alone or at least two kinds can be used as combined. The amount of the stabilization promoter to be used is not also specifically limited and may be the range not deteriorating the object of the present invention. If used, however, the amount of the stabilization promoter is preferably at most 3 parts by weight relative to 100 parts by weight of the vinyl chloride resin.

The processing aid is not also specifically limited, and any one not deteriorating the object of the present invention may be employed herein. It includes, for example, acryl-type processing aids such as a n-butyl acrylate/methyl methacrylate copolymer, 2-ethylhexyl acrylate/methyl methacrylate copolymer, 2-ethylhexyl acrylate/methyl methacrylate/n-butyl methacrylate copolymer. These may be used alone or at least two kinds can be used as combined. The amount of the processing aid to be used is not also specifically limited and may be the range not deteriorating the object of the present invention. If used, however, the amount of the stabilization promoter is preferably at most 10 parts by weight relative to 100 parts by weight of the vinyl chloride resin.

The filler is not also specifically limited, and any one not deteriorating the object of the present invention may be employed herein. It includes, for example, calcium carbonate, magnesium carbonate, lithium carbonate, kaolin clay, plaster, mica, talc, magnesium hydroxide, calcium silicate, and borax. These may be used alone or at least two kinds can be used as combined. The amount of filler to be used is not also specifically limited and may be the range not deteriorating the object of the present invention. If used, however, the amount of the filler is preferably at most 1,000 parts by weight relative to 100 parts by weight of the vinyl chloride resin.

The antioxidant is not also specifically limited, and any one not deteriorating the object of the present invention may be employed herein. It includes, for example, phenol antioxidants. These may be used alone or at least two kinds can be used as combined. The amount of the antioxidant to be used is not also specifically limited and may be the range not deteriorating the object of the present invention. If used, however, the amount of the antioxidant is preferably at most 5 parts by weight relative to 100 parts by weight of the vinyl chloride resin.

The light stabilizer is not also specifically limited, and any one not deteriorating the object of the present invention may be employed herein. It includes, for example, UV absorbents such as salicylate ester compounds, benzophenone compounds, benzotriazole compounds, cyanoacrylate compounds; and hindered amine-type light stabilizers. These may be used alone or at least two kinds can be used as combined. The amount of the light stabilizer to be used is not also specifically limited and may be the range not deteriorating the object of the present invention. If used, however, the amount of the light stabilizer is preferably at most 5 parts by weight relative to 100 parts by weight of the vinyl chloride resin.

The pigment is not also specifically limited, and any one not deteriorating the object of the present invention may be employed herein. It includes, for example, organic pigments such as azo compounds, phthalocyanine compounds, threne compounds, dye lakes; and inorganic pigments such as oxides, molybdenum chromate compounds, sulfide-selenides, ferrocyanates. These may be used alone or at least two kinds can be used as combined. The amount of the pigment to be used is not also specifically limited and may be the range not deteriorating the object of the present invention. If used, however, the amount of the pigment is preferably at most 5 parts by weight relative to 100 parts by weight of the vinyl chloride resin.

The plasticizer is not also specifically limited, and any one not deteriorating the object of the present invention may be employed herein. It includes, for example, phthalate ester plasticizers such as di-2-ethylhexyl phthalate, di-n-octyl phthalate, diisononyl phthalate, and dibutyl phthalate; phosphoric ester plasticizers such as tricresyl phosphate, trixylyl phosphate, triphenyl phosphate; fatty acid ester plasticizers such as di-2-ethylhexyl adipate, di-2-ethylhexyl sebacate. These may be used alone or at least two kinds can be used as combined. The amount of the plasticizer to be used is not also specifically limited and may be the range not deteriorating the object of the present invention. If used, however, the amount of the plasticizer is preferably at most 100 parts by weight relative to 100 parts by weight of the vinyl chloride resin.

Also not deteriorating the object of the present invention, the resin composition of the present invention may contain any other additives such as flame retardant, antistatic agent, reinforcing agent and reinforcing agent with no specific limitation thereon, if necessary. The amount of the additives usable herein is not also specifically limited, and may be the range not deteriorating the object of the present invention.

The method for producing the vinyl chloride resin composition of the present invention is not specifically limited. Briefly, the vinyl chloride copolymer resin of the present invention and vinyl chloride resin are compounded in a predetermined ratio, and, if necessary, optional additives (e.g., a thermal stabilizer, lubricant, stabilization promoter, processing aid, filler, antioxidant, light stabilizer, pigment, plasticizer, further, flame retardant, antistatic agent, reinforcing agent, modifier) are added thereto. These are uniformly mixed or mixed and kneaded in an ordinary manner of hot blending or cold blending, by the use of a mixing machine and/or a mixing-kneading machine such as ribbon blender, super-mixer, tumbler mixer, Banbury mixer, Henschel mixer, and mixing roll. In this process, the order of mixing the components is not specifically limited. Not deteriorating the object of the present invention, any technique may be employed in any desired manner. For example, a vinyl chloride resin, a vinyl chloride copolymer resin and additives are mixed all at a time; or, for the purpose of uniformly mixing liquid additives, a vinyl chloride resin, a vinyl chloride copolymer resin and powdery additives are firstly mixed, and then liquid additives are added to the resulting mixture; or a vinyl chloride resin and a vinyl chloride copolymer resin are firstly mixed, then liquid additives are added thereto, and finally powdery additives are added thereto; or a vinyl chloride resin is firstly mixed with additives and then a vinyl chloride copolymer resin is added thereto.

The vinyl chloride resin composition of the present invention thus produced may be provided to be molded in various molding methods into articles, directly as it is or after further kneaded or kneaded and granulated by the use of a kneading machine and/or a kneading and granulating machine such as cokneader, extruder or pelletizer.

### EXAMPLES

The present invention is explained in detail on the basis of examples, but is not limited to the following examples. Herein, “part” and “%” in the examples indicate “part by weight” and “% by weight” respectively, unless otherwise specified.

### <Preparation of a Macromonomer Having a Polymer Comprising an Ethylenically Unsaturated Monomer Containing a Double Bond in a Main Chain>

The preparation of a macromonomer having a polymer comprising an ethylenically unsaturated monomer containing a double bond in a main chain was performed in accordance with the procedure described in the following Preparation Examples.

### Preparation Example 1

CuBr (5.54 g) was charged into a 2 L-separable flask with a reflux tube and a stirrer, and the inside of the reaction vessel was substituted with nitrogen. Acetonitrile (73.8 ml) was added thereto and stirred in an oil bath at a temperature of 70° C. for 30 minutes. N-butyl acrylate (132 g), methyl 2-bromopropionate (7.2 ml) and pentamethyldiethylenetriamine (4.69 ml) were added thereto to initiate a reaction. N-butyl acrylate (528 g) was continuously dropped thereinto over 90 minutes while stirred by heating at a temperature of 70° C., and further stirred by heating for 80 minutes.

After the reaction mixture was diluted with toluene and passed through an activated alumina column, a poly(n-butyl acrylate) having a Br group at one end by distilling off the volatile component at a reduced pressure was obtained.

Methanol (800 ml) was charged into the flask and cooled to a temperature of 0° C. T-butoxy potassium (130 g) was added thereto with a division into several times. This reaction solution was maintained at a temperature of 0° C. and thereto was dropped a methanol solution of acrylic acid (100 g). After completing the dropping, a temperature of the reaction solution was returned from 0° C. to a room temperature, and then, potassium acrylate (CH₂═CHCO₂K) was obtained by distilling off the volatile component of the reaction solution at a reduced pressure.

The obtained poly(n-butyl acrylate) having a Br group at one end (150 g), potassium acrylate (7.45 g) and dimethylacetamide (150 ml) were charged into a 500 mL-flask with a reflux tube and stirred by heating at a temperature of 70° C. for 3 hours. After the dimethylacetamide was distilled off from the reaction mixture, which was dissolved in toluene and passed through an activated alumina column, a poly(n-butyl acrylate) macromonomer having an acryloyl group at one end was obtained by distilling off the toluene.

### <Preparation of Vinyl Chloride Copolymer Resin Obtained by Copolymerizing a Vinyl Monomer and a Macromonomer Having a Polymer Comprising an Ethylenically Unsaturated Monomer Containing a Double Bond in a Main Chain>

The preparation of vinyl chloride copolymer resin obtained by copolymerizing a vinyl monomer and a macromonomer having as a main chain a polymer comprising an ethylenically unsaturated monomer containing a double bond was performed in accordance with the procedure described in the following Preparation examples.

### Preparation Example A

### Preparation of Vinyl Chloride Copolymer Resin Having a Partial Content of Macromonomer Component of 3%

A stainless-steel polymerization reactor of a 25-liter internal capacity provided with a jacket and a stirrer was deaerated, and thereafter 97 parts of vinyl chloride monomer was charged thereinto and subsequently 3 parts of a poly(n-butyl acrylate) macromonomer having an acryloyl group at one end of Preparation Example 1 was charged, then supply hot water to the jacket for heating the inside of the polymerization reactor up to a temperature of 30° C. and stir at a rotational speed of 900 per minute for 5 minutes. After supplying water to the jacket for cooling the inside of the polymerization reactor to a temperature of at most 20° C., 0.1 part of a partially saponified polyvinyl acetate having a degree of saponification of approximately 80 mol % and an average degree of polymerization of approximately 2000, 0.0216 part of t-butylperoxyneodecanoate and 0.024 part of di(3,5,5-trimethylhexanoyl) peroxide were charged thereto, then, charge 150 parts of hot water of 60° C. and polymerized at a polymerization temperature of 66.5° C. for approximately 6 hours. After the unreacted monomer in the polymerization reactor was recovered, the polymerization reactor was cooled to drive out slurry. The obtained slurry was dehydrated and dried by a hot-air dryer at a temperature of 55° C. for 24 hours to obtain polyvinyl chloride)-graft-poly(n-butyl acrylate) resin A as white powder.

### Preparation Example B

### Preparation of Vinyl Chloride Copolymer Resin Having a Partial Content of Macromonomer Component of 5%

Poly(vinyl chloride)-graft-poly(n-butyl acrylate) resin B was obtained as white powder in the same manner as Preparation Example except for charging 95 parts of vinyl chloride monomer and 5 parts of a Poly(n-butyl acrylate) macromonomer having an acryloyl group at one end of Preparation Example 1 in Preparation Example A.

### Preparation Example C

### Preparation of Vinyl Chloride Copolymer Resin Having a Partial Content of Macromonomer Component of 20%

Poly(vinyl chloride)-graft-poly(n-butyl acrylate) resin C was obtained as white powder in the same manner as Preparation Example A except for charging 80 parts of vinyl chloride monomer and 20 parts of a poly(n-butyl acrylate) macromonomer having an acryloyl group at one end of Preparation Example 1 in Preparation Example A.

### Preparation Example D

### Preparation of Vinyl Chloride Copolymer Resin Having a Partial Content of Macromonomer Component of 50%

Poly(vinyl chloride)-graft-poly(n-butyl acrylate) resin D was obtained as white powder in the same manner as Preparation Example A except for charging 50 parts of vinyl chloride monomer and 50 parts of a poly(n-butyl acrylate) macromonomer having an acryloyl group at one end of Preparation Example 1 in Preparation Example A.

### Example 1

100 parts of an ordinary poly(vinyl chloride) resin (KANEKA CORPORATION's KANEVINYL S1001, vinyl chloride homopolymer resin having a K value of 68), 2 parts of an organic tin thermal stabilizer (Nitto Chemical's TVS#8831, dioctyltin mercaptide), 0.3 part of a dibasic acid ester lubricant (Cognis Japan's Loxiol G-60), and 0.3 part of a partially-saponified montanate ester lubricant (Hoechst Japan's Wax-OP) were mixed in a Henschel mixer so that the resin temperature become 110° C., and then cooled to 50° C. or lower. The poly(vinyl chloride)-graft-poly(n-butyl acrylate) resin B obtained in Preparation Example B was added thereto in an amount of 2 parts relative to 100 parts of the poly(vinyl chloride) resin, thereby to obtain a vinyl chloride resin composition. Using 8-inch rolls of Nippon Roll Manufacture's HOS-2103 Model (outer diameter, about 20 cm), the resulting composition was rolled at 180° C. for 5 minutes into a roll sheet having a thickness of about 1 mm, under the condition of 20 rpm for the front roll and 18 rpm for the rear roll. The resulting roll sheet was divided into two. One was cut into pieces of about 3 mm×3 mm, and used for evaluation of the melt flow property. The other was cut into pieces of a predetermined size, and tens of the pieces were piled up and pressed for about 10 minutes at 185° C. under a pressure of 5 MPa, using a hydraulic press of Shindo Metal Industry's Shindo Model SF, to give 5 mm-thick test plates. Next, these were cut and machined into test samples for evaluation of the softening temperature and into those for evaluation of the impact-resistant strength and the tensile strength as mechanical strength properties, and these samples were provided to each measurement.

The melt flow property, the softening temperature, the impact-resistant strength and the tensile strength were determined and evaluated according to the methods mentioned below.

### (a) Melt Flow Property:

According to the test method for flow of thermoplastic resin, stipulated in the attached sheet C of JIS K7210, and using a polymer chemistry type flow tester, Shimadzu's CFT-500C Model, the resin flow value per second of the sample resin was measured (hereinafter referred to as “Polymer chemistry type B-method flow value”, the unit is ml/sec×10⁻²). The test temperature was 180° C.; the die length was 1 mm; the die diameter was 1 mm; and the test load was 9.8×10² N.

### (b) Softening Temperature:

According to the Vicat softening temperature test method stipulated in JIS K7206, a test piece having a length of 20 mm, a width of 20 mm and a thickness of 3 mm was left in a temperature/humidity-controlled chamber at room temperature of 23° C. and a relative humidity of 50% for 88 hours, and its Vicat softening temperature (° C.) was measured. The temperature of the sample at the start of the test was 40° C.; the sample heating temperature rate was 50° C./hr; and the test load was 50 N.

### (c) Impact-Resistant Strength:

According to the Izod impact strength test method stipulated in JIS K7110, a test piece of type 1 was cut and machined to make it have a notch of type A. The thus-notched test piece was tested for its Izod impact strength (kJ/m²) at 23° C. and 0° C. When the sample was tested at 23° C., it was previously left in a temperature/humidity-controlled chamber at room temperature of 23° C. and a relative humidity of 50% for 48 hours. When the sample is tested at 0° C., it is previously left in a temperature/humidity-controlled chamber at room temperature of 23° C. and a relative humidity of 50% for 48 hours, and then dipped in a liquid tank controlled to be 0° C., for 5 minutes. Within 5 seconds after taken out of the liquid tank, impact was applied to the sample.

### (d) Tensile Strength:

According to the tensile test method stipulated in JIS K7162, a 1A-type test sample was left in a temperature/humidity-controlled chamber at room temperature of 23° C. and a relative humidity of 50% for 48 hours, and its tensile strength (hereinafter referred to as σy; the unit is MPa) at 23° C. is measured at a test speed of 10 mm/min. The results are shown in Table 1.

The content of the poly(n-butyl acrylate) macromonomer component in the composition was 0.1 part based on 100 parts of the poly(vinyl chloride) resin therein.

### Example 2

A vinyl chloride resin composition was produced in the same manner as in Example 1 except that 10 parts of the poly(vinyl chloride)-graft-poly(n-butyl acrylate) resin A obtained in Preparation Example A was added, in place of the poly(vinyl chloride)-graft-poly(n-butyl acrylate) resin B obtained in Preparation Example B, to 100 parts of poly(vinyl chloride) resin. Also in the same manner as in Example 1, the composition was rolled/pressed, and the samples were tested for the B-method flow value, the Vicat softening temperature, the Izod impact strength and the value σy thereof. The results are shown in Table 1.

The content of the poly(n-butyl acrylate) macromonomer component in the composition was 0.3 part based on 100 parts of the poly(vinyl chloride) resin therein.

### Example 3

A vinyl chloride resin composition was produced in the same manner as in Example 1 except that 0.5 part of the poly(vinyl chloride)-graft-poly(n-butyl acrylate) resin C obtained in Preparation Example C was added, in place of the poly(vinyl chloride)-graft-poly(n-butyl acrylate) resin B obtained in Preparation Example B, to 100 parts of poly(vinyl chloride) resin. Also in the same manner as in Example 1, the composition was rolled/pressed, and the samples were tested for the B-method flow value, the Vicat softening temperature, the Izod impact strength and the value σy thereof. The results are shown in Table 1.

The content of the poly(n-butyl acrylate) macromonomer component in the composition was 0.1 part based on 100 parts of the poly(vinyl chloride) resin therein.

### Example 4

A vinyl chloride resin composition was produced in the same manner as in Example 3 except that 5 parts of the poly(vinyl chloride)-graft-poly(n-butyl acrylate) resin C was added to 100 parts of poly(vinyl chloride) resin. Also in the same manner as in Example 3, the composition was rolled/pressed, and the samples were tested for the B-method flow value, the Vicat softening temperature, the Izod impact strength and the value σy thereof. The results are shown in Table 1.

The content of the poly(n-butyl acrylate) macromonomer component in the composition was 1 part based on 100 parts of the poly(vinyl chloride) resin therein.

### Example 5

A vinyl chloride resin composition was produced in the same manner as in Example 1 except that 0.2 part of the poly(vinyl chloride)-graft-poly(n-butyl acrylate) resin D obtained in Preparation Example D was added, in place of the poly(vinyl chloride)-graft-poly(n-butyl acrylate) resin B obtained in Preparation Example B, to 100 parts of poly(vinyl chloride) resin. Also in the same manner as in Example 1, the composition was rolled/pressed, and the samples were tested for the B-method flow value, the Vicat softening temperature, the Izod impact strength and the value σy thereof. The results are shown in Table 1.

The content of the poly(n-butyl acrylate) macromonomer component in the composition was 0.1 part based on 100 parts of the poly(vinyl chloride) resin therein.

### Example 6

A vinyl chloride resin composition was produced in the same manner as in Example 5 except that 10 parts of the poly(vinyl chloride)-graft-poly(n-butyl acrylate) resin D was added to 100 parts of poly(vinyl chloride) resin. Also in the same manner as in Example 5, the composition was rolled/pressed, and the samples were tested for the B-method flow value, the Vicat softening temperature, the Izod impact strength and the value σy thereof. The results are shown in Table 1.

The content of the poly(n-butyl acrylate) macromonomer component in the composition was 5 parts based on 100 parts of the poly(vinyl chloride) resin therein.

### Comparative Example 1

A vinyl chloride resin composition was produced in the same manner as in Example 1, to which, however, the poly(vinyl chloride)-graft-poly(n-butyl acrylate) resin B obtained in Preparation Example B was not added. Also in the same manner as in Example 1, the composition was rolled/pressed, and the samples were tested for the B-method flow value, the Vicat softening temperature, the Izod impact strength and the value σy thereof. The results are shown in Table 1. Unfavorably, the B-method flow value, the Izod impact strength and the value σy of the samples were all lower than those of the samples of Examples 1 to 6.

### Comparative Example 2

A vinyl chloride resin composition was produced in the same manner as in Comparative Example 1, to which, however, 10 parts of a plasticizer, di-2-ethylhexyl phthalate (J-plus's DOP) was added. Also in the same manner as in Comparative Example 1, the composition was rolled/pressed, and the samples were tested for the B-method flow value, the Vicat softening temperature, the Izod impact strength and the value σy thereof. The results are shown in Table 1. Unfavorably, the Vicat softening temperature, the Izod impact strength and the value σy of the samples were all lower than those of the samples of Comparative Example 1.

### Comparative Example 3

A vinyl chloride resin composition was produced in the same manner as in Comparative Example 1, to which, however, 2 parts of a methyl methacrylate processing aid (Mitsubishi Rayon's Metablen P-551A) was added. Also in the same manner as in Comparative Example 1, the composition was rolled/pressed, and the samples were tested for the B-method flow value, the Vicat softening temperature, the Izod impact strength and the value σy thereof. The results are shown in Table 1. Unfavorably, the Vicat softening temperature, the Izod impact strength and the value σy of the samples were all lower than those of the samples of Comparative Example 1.

### Comparative Example 4

A vinyl chloride resin composition was produced in the same manner as in Comparative Example 1, to which, however, 3 parts of an impact modifier (Mitsubishi Rayon's Metablen C-323A, MBS resin) was added. Also in the same manner as in Comparative Example 1, the composition was rolled/pressed, and the samples were tested for the B-method flow value, the Vicat softening temperature, the Izod impact strength and the value σy thereof. The results are shown in Table 1. The B-method flow value, the Vicat softening temperature and the value σy of the samples were all lower than those of the samples of Comparative Example 1. This means that the effect of the impact modifier used herein was unsatisfactory.

### Comparative Example 5

A vinyl chloride resin composition was produced in the same manner as in Example 1 except that 1 part of the poly(vinyl chloride)-graft-poly(n-butyl acrylate) resin A obtained in Preparation Example A was added to 100 parts of poly(vinyl chloride) resin as in Example 2. Also in the same manner as in Example 1, the composition was rolled/pressed, and the samples were tested for the B-method flow value, the Vicat softening temperature, the Izod impact strength and the value σy thereof. The results are shown in Table 1. The physical values of the samples were all lower than those of the samples of Comparative Example 1. This means that the composition was ineffective.

The content of the poly(n-butyl acrylate) macromonomer component in the composition was 0.03 part based on 100 parts of the poly(vinyl chloride) resin therein.

### Comparative Example 6

A vinyl chloride resin composition was produced in the same manner as in Example 5 except that 20 parts of the poly(vinyl chloride)-graft-poly(n-butyl acrylate) resin D obtained in Preparation Example D was added to 100 parts of poly(vinyl chloride) resin. Also in the same manner as in Example 5, the composition was rolled/pressed, and the samples were tested for the B-method flow value, the Vicat softening temperature, the Izod impact strength and the value σy thereof. The results are shown in Table 1. Unfavorably, the Vicat softening temperature, the Izod impact strength and the value σy of the samples were all lower than those of the samples of Comparative Example 1.

The content of the poly(n-butyl acrylate) macromonomer component in the composition was 10 parts based on 100 parts of the poly(vinyl chloride) resin therein.

TABLE 1

| | | Partial content of | Amount of vinyl | Content of | Additives other | | | | | |
|---|---|---|---|---|---|---|---|---|---|---|
| | | macromonomer | chloride | macromonomer | than vinyl chloride | | | | | |
| | | component in | copolymer resin | component based | resin, vinyl chloride | | | Izod | | |
| | | the entire vinyl | added to 100 | on 100 parts by | copolymer resin, | B-method | Vicat | impact | | |
| | | chloride | parts by weight of | weight of vinyl | thermal stabilizer | flow value | Softening | strength | | |
| | | copolymer resin | vinyl chloride resin | chloride resin | and lubricant, | ml/sec × | temperature | (kJ/m²) | | σy |
| | | (% by weight): X | (part by weight): Y | (part by weight): Z*¹⁾ | and their amount | 10⁻² | (° C.) | 0° C. | 23° C. | (MPa) |
| Ex. | 1 | 5 | 2 | 0.1 | no | 2.5 | 80.2 | 3.3 | 6.3 | 48.2 |
| | 2 | 3 | 10 | 0.3 | no | 3.3 | 80.0 | 3.5 | 6.8 | 49.3 |
| | 3 | 20 | 0.5 | 0.1 | no | 2.8 | 80.2 | 3.2 | 6.0 | 47.8 |
| | 4 | 20 | 5 | 1 | no | 4.0 | 79.8 | 3.8 | 7.3 | 49.7 |
| | 5 | 50 | 0.2 | 0.1 | no | 3.0 | 80.2 | 3.2 | 6.0 | 48.0 |
| | 6 | 50 | 10 | 5 | no | 5.4 | 79.2 | 4.0 | 7.5 | 50.1 |
| Com. | 1 | — | 0 | 0 | no | 0.6 | 80.0 | 3.0 | 4.7 | 46.0 |
| Ex. | 2 | — | 0 | 0 | DOP | 7.6 | 66.2 | 3.5 | 5.0 | 38.9 |
| | | | | | 10 parts by weight | | | | | |
| | 3 | — | 0 | 0 | Processing aid*²⁾ | 1.0 | 80.2 | 2.5 | 3.8 | 41.8 |
| | | | | | 2 parts by weight | | | | | |
| | 4 | — | 0 | 0 | MBS resin | 0.7 | 80.5 | 7.5 | 9.8 | 43.5 |
| | | | | | 3 parts by weight | | | | | |
| | 5 | 3 | 1 | 0.03 | no | 0.6 | 78.0 | 2.9 | 4.6 | 45.9 |
| | 6 | 50 | 20 | 10 | no | 10.2 | 73.6 | 3.0 | 3.7 | 42.3 |

*¹⁾When poly(vinyl chloride)-graft-poly(n-butyl acrylate) resin is added to poly(vinyl chloride) resin, the value is calculated according to the following formula: Z = X × Y + 100
wherein Z indicates the content of the macromonomer component based on 100 parts by weight of the vinyl chloride resin (part by weight);
X indicates the partial content of the macromonomer component in the entire vinyl chloride copolymer resin (% by weight); and
Y indicates the amount of the vinyl chloride copolymer resin added to 100 parts by weight of the vinyl chloride resin (part by weight).
*²⁾Processing aid: methyl methacrylate processing aid

### Example 7

100 parts of an ordinary poly(vinyl chloride) resin (KANEKA CORPORATION's KANEVINYL S1008, a vinyl chloride homopolymer resin having a K value of 60), 1.2 parts of an organic tin thermal stabilizer (Kyodo Yakuhin's T-17MOK, octyltin mercaptide), 1.6 parts of a polymer complex ester lubricant (Cognis Japan's Loxiol G-74), 0.9 part of a polyol ester lubricant (Cognis Japan's Loxiol G-16), and 10 parts of an impact modifier (KANEKA CORPORATION's KANEACE B-51, methyl methacrylate/butadiene/styrene copolymer, hereinafter referred to as MBS resin) were mixed in a Henschel mixer so that the resin temperature become 110° C., and then cooled to 50° C. or lower. The poly(vinyl chloride)-graft-poly(n-butyl acrylate) resin B obtained in Preparation Example B was added thereto in an amount of 2 parts relative to 100 parts of the poly(vinyl chloride) resin, thereby to obtain a vinyl chloride resin composition. Using 8-inch rolls of Nippon Roll Manufacture's HOS-2103 Model (outer diameter, about 20 cm), the resulting composition was rolled at 180° C. for 3 minutes into a roll sheet having a thickness of about 1.0 mm and a width of 30 cm, under the condition of 15 rpm for the front roll and 16 rpm for the rear roll. The resulting roll sheet was visually checked for air marks, and evaluated in 5 ranks according to the standards mentioned below.

5: No air mark found at all.

4: Few air marks found.

3: Some air marks found with no practical problem.

2: Some air marks found with some practical problems.

1: Air marks remarkably found with bad sheet surface condition.

The results are shown in Table 2.

The content of the poly(n-butyl acrylate) macromonomer component in the composition was 0.1 part based on 100 parts of the poly(vinyl chloride) resin therein.

100 parts of an ordinary poly(vinyl chloride) resin (KANEKA CORPORATION's KANEVINYL S1008, a vinyl chloride homopolymer resin having a K value of 60), 1 part of an organic tin thermal stabilizer (Crompton's MARK 17M, octyltin mercaptide), 0.3 part of a special ester lubricant (Cognis Japan's Loxiol G-70S), 0.4 part of a polyol ester lubricant (Cognis Japan's Loxiol G-16), and 6 parts of an impact modifier (KANEKA CORPORATION's KANEACE B-521, MBS resin) were mixed in a Henschel mixer so that the resin temperature become 110° C., and then cooled to 50° C. or lower. The poly(vinyl chloride)-graft-poly(n-butyl acrylate) resin B obtained in Preparation Example B was added thereto in an amount of 2 parts relative to 100 parts of the poly(vinyl chloride) resin, thereby to obtain a vinyl chloride resin Composition. Using 8-inch rolls of Nippon Roll Manufacture's HOS-2103 Model (outer diameter, about 20 cm), the resulting Composition was rolled at 200° C. for 3 minutes into a roll sheet having a thickness of about 0.5 mm and a width of 35 cm, under the condition of 17 rpm for the front roll and 16 rpm for the rear roll. The resulting roll sheet was visually checked for flow marks, and evaluated in 5 ranks according to the standards mentioned below.

5: No flow mark found at all.

4: Few flow marks found.

3: Some flow marks found with no practical problem.

2: Some flow marks found with some practical problems.

1: Flow marks remarkably found with bad sheet surface condition.

The results are shown in Table 2.

The content of the poly(n-butyl acrylate) macromonomer Component in the composition was 0.1 part based on 100 parts of the poly(vinyl chloride) resin therein.

### Example 8

A vinyl chloride resin composition was produced in the same manner as in Example 7 except that 0.5 part of the poly(vinyl chloride)-graft-poly(n-butyl acrylate) resin C obtained in Preparation Example C was added, in place of the poly(vinyl chloride)-graft-poly(n-butyl acrylate) resin B obtained in Preparation Example B, to 100 parts of poly(vinyl chloride) resin. Also in the same manner as in Example 7, the composition was rolled into sheets, and checked for air marks and flow marks. The results are shown in Table 2.

The content of the poly(n-butyl acrylate) macromonomer component in the composition was 0.1 part based on 100 parts of the poly(vinyl chloride) resin therein.

### Example 9

A vinyl chloride resin composition was produced in the same manner as in Example 8 except that 5 parts of the poly(vinyl chloride)-graft-poly(n-butyl acrylate) resin C was added to 100 parts of poly(vinyl chloride) resin. Also in the same manner as in Example 8, the composition was rolled into sheets, and checked for air marks and flow marks. The results are shown in Table 2.

The content of the poly(n-butyl acrylate) macromonomer component in the composition was 1 part based on 100 parts of the poly(vinyl chloride) resin therein.

### Example 10

A vinyl chloride resin composition was produced in the Same manner as in Example 7 except that 0.2 part of the poly(vinyl chloride)-graft-poly(n-butyl acrylate) resin D obtained in Preparation Example D was added, in place of the poly(vinyl chloride)-graft-poly(n-butyl acrylate) resin B obtained in Preparation Example B, to 100 parts of poly(vinyl chloride) resin. Also in the same manner as in Example 7, the composition was rolled into sheets, and checked for air marks and flow marks. The results are shown in Table 2.

The content of the poly(n-butyl acrylate) macromonomer component in the composition was 0.1 part based on 100 parts of the poly(vinyl chloride) resin therein.

### Example 11

A vinyl chloride resin composition was produced in the same manner as in Example 10 except that 10 parts of the poly(vinyl chloride)-graft-poly(n-butyl acrylate) resin D was added to 100 parts of poly(vinyl chloride) resin. Also in the same manner as in Example 10, the composition was rolled into sheets, and checked for air marks and flow marks. The results are shown in Table 2.

The content of the poly(n-butyl acrylate) macromonomer component in the composition was 5 parts based on 100 parts of the poly(vinyl chloride) resin therein.

### Comparative Example 7

A vinyl chloride resin composition was produced in the same manner as in Example 7, to which, however, the poly(vinyl chloride)-graft-poly(n-butyl acrylate) resin B obtained in Preparation Example B was not added. Also in the same manner as in Example 1, the composition was rolled into sheets, and checked for air marks and flow marks. The results are shown in Table 2. Unfavorably, the sheets were poorer with respect to air marks and flow marks than those of the sheets of Examples 7 to 11.

### Comparative Example 8

A vinyl chloride resin composition was produced in the same manner as in Comparative Example 7, to which, however, 2 parts of a methyl methacrylate-type processing aid (Mitsubishi Rayon's Metablen P-551A) was added. Also in the same manner as in Comparative Example 7, the composition was rolled into sheets, and checked for air marks and flow marks. The results are shown in Table 2. The sheets were poorer with respect to flow marks than those of the sheets of Examples 7 to 11. This means that the effect of the processing aid used herein was unsatisfactory.

### Comparative Example 9

A vinyl chloride resin composition was produced in the same manner as in Comparative Example 7, to which, however, 10 parts of a plasticizer, di-2-ethylhexyl phthalate (J-plus's DOP, hereinafter referred to as DOP) was added. Also in the same manner as in Comparative Example 7, the composition was rolled into sheets, and checked for air marks and flow marks. The results are shown in Table 2. The sheets were poorer with respect to flow marks than those of the sheets of Examples 7 to 11. This means that the effect of the plasticizer used herein was unsatisfactory.

### Comparative Example 10

A vinyl chloride resin composition was produced in the same manner as in Example 7 except that 1 part of the poly(vinyl Chloride)-graft-poly(n-butyl acrylate) resin B obtained in Preparation Example B was added to 100 parts of poly(vinyl chloride) resin. Also in the same manner as in Example 7, the composition was rolled into sheets, and checked for air marks and flow marks. The results are shown in Table 2. The sheets were poorer with respect to air marks than those of the sheets of Examples 7 to 11. This means that the composition was ineffective.

The content of the poly(n-butyl acrylate) macromonomer Component in the composition was 0.05 part based on 100 parts of the Poly(vinyl chloride) resin therein.

### Comparative Example 11

A vinyl chloride resin composition was produced in the Same manner as in Example 8 except that 0.1 part of the poly(vinyl chloride)-graft-poly(n-butyl acrylate) resin C obtained in Preparation Example C was added to 100 parts of poly(vinyl chloride) resin. Also in the same manner as in Example 8, the composition was rolled into sheets, and checked for air marks and flow marks. The results are shown in Table 2. Unfavorably, the sheets were poorer with respect to air marks and flow marks than those of the sheets of Examples 7 to 11.

The content of the poly(n-butyl acrylate) macromonomer component in the composition was 0.02 part based on 100 parts of the poly(vinyl chloride) resin therein.

### Comparative Example 12

A vinyl chloride resin composition was produced in the same manner as in Example 8 except that 30 parts of the poly(vinyl chloride)-graft-poly(n-butyl acrylate) resin C obtained in Preparation Example C was added to 100 parts of poly(vinyl chloride) resin. Also in the same manner as in Example 8, the composition was rolled into sheets, and checked for air marks and flow marks. The results are shown in Table 2. Unfavorably, the sheets more air marks and more flow marks than those of the sheets of Examples 7 to 11.

The content of the poly(n-butyl acrylate) macromonomer component in the composition was 6 parts based on 100 parts of the poly(vinyl chloride) resin therein.

### Comparative Example 13

A vinyl chloride resin composition was produced in the same manner as in Example 10 except that 0.1 part of the poly(vinyl chloride)-graft-poly(n-butyl acrylate) resin D obtained in Preparation Example D was added to 100 parts of poly(vinyl chloride) resin. Also in the same manner as in Example 10, the composition was rolled into sheets, and checked for air marks and flow marks. The results are shown in Table 2. The sheets were poorer with respect to flow marks than those of the sheets of Examples 7 to 11. This means that the composition was ineffective.

The content of the poly(n-butyl acrylate) macromonomer component in the composition was 0.05 part based on 100 parts of the poly(vinyl chloride) resin therein.

### Comparative Example 14

A vinyl chloride resin composition was produced in the same manner as in Example 10 except that 20 parts of the poly(vinyl chloride)-graft-poly(n-butyl acrylate) resin D obtained in Preparation Example D was added to 100 parts of poly(vinyl chloride) resin. Also in the same manner as in Example 10, the composition was rolled into sheets, and checked for air marks and flow marks. The results are shown in Table 2. Unfavorably, the sheets were poorer with respect to air marks and flow marks than those of the sheets of Examples 7 to 11.

The content of the poly(n-butyl acrylate) macromonomer Component in the composition was 10 parts based on 100 parts of the poly(vinyl chloride) resin therein.

TABLE 2

| | | Partial content of | Amount of vinyl | Content of macromonomer | Amount of | | | |
|---|---|---|---|---|---|---|---|---|
| | | macromonomer component | chloride | component based on 100 | processing | Amount of | | |
| | | in the entire vinyl chloride | copolymer resin | parts by weight of vinyl | aid | plasticizer | | |
| | | copolymer resin | (part by | chloride resin | (part by | (part by | Air | Flow |
| | | (% by weight): X | weight): Y | (part by weight): Z*¹⁾ | weight)*²⁾ | weight)*³⁾ | marks*⁴⁾ | marks*⁴⁾ |
| Ex. | 7 | 5 | 2 | 0.1 | 0 | 0 | 5 | 4 |
| | 8 | 20 | 0.5 | 0.1 | 0 | 0 | 5 | 5 |
| | 9 | 20 | 5 | 1 | 0 | 0 | 4 | 5 |
| | 10 | 50 | 0.2 | 0.1 | 0 | 0 | 5 | 5 |
| | 11 | 50 | 10 | 5 | 0 | 0 | 3 | 3 |
| Com. | 7 | — | 0 | 0 | 0 | 0 | 1 | 1 |
| Ex. | 8 | — | 0 | 0 | 2 | 0 | 4 | 2 |
| | 9 | — | 0 | 0 | 0 | 10 | 3 | 2 |
| | 10 | 5 | 1 | 0.05 | 0 | 0 | 2 | 3 |
| | 11 | 20 | 0.1 | 0.02 | 0 | 0 | 2 | 2 |
| | 12 | 20 | 30 | 6 | 0 | 0 | 2 | 1 |
| | 13 | 50 | 0.1 | 0.05 | 0 | 0 | 3 | 2 |
| | 14 | 50 | 20 | 10 | 0 | 0 | 2 | 1 |

*¹⁾When poly(vinyl chloride)-graft-poly(n-butyl acrylate) resin is added to poly(vinyl chloride) resin, the value is calculated according to the following formula: Z = X × Y + 100
wherein Z indicates the content of the macromonomer component based on 100 parts by weight of the vinyl chloride resin (part by weight);
X indicates the partial content of the macromonomer component in the entire vinyl chloride copolymer resin (% by weight); and
Y indicates the amount of the vinyl chloride copolymer resin added to 100 parts by weight of the vinyl chloride resin (part by weight).
*²⁾Processing aid: methyl methacrylate-type processing aid
*³⁾Plasticizer: DOP
*⁴⁾Standards for judging air marks and flow marks:
Air marks:
5: No air mark found at all.
4: Few air marks found.
3: Some air marks found with no practical problem.
2: Some air marks found with some practical problems.
1: Air marks remarkably found with bad sheet surface condition.
Flow marks:
5: No flow mark found at all.
4: Few flow marks found.
3: Some flow marks found with no practical problem.
2: Some flow marks found with some practical problems.
1: Flow marks remarkably found with bad sheet surface condition.

### Example 12

100 parts of an ordinary poly(vinyl chloride) resin (KANEKA CORPORATION's KANEVINYL S1007, a vinyl chloride homopolymer resin having a K value of 57), 2.0 parts of an organic tin thermal stabilizer (Nitto Chemical's TVS#8831, dioctyltin mercaptide), 0.2 part of a Polyethylene oxide lubricant (Allied Chemical's ACPE629A), and 0.5 part of a dibasic acid ester lubricant (Cognis Japan's Loxiol G-60) were mixed in a Henschel mixer so that the resin temperature become 110° C., and then cooled to 50° C. or lower. The poly(vinyl chloride)-graft-poly(n-butyl acrylate) resin B obtained in Preparation Example B was added thereto in an amount of 2 parts relative to 100 parts of the poly(vinyl chloride) resin, thereby to obtain a vinyl chloride resin composition. The composition was fed into a single-screw extruder (Tanabe Plastic Machinery's extruder FH50-239, VS 50 m/m), and the extruded strand was pelletized with a pelletizer (Isuzu Kakoki's plastic processor SCF-100). The pellets were fed into an injection-molding machine (Fanuc's Auto Shot T Series 75D) to determine the spiral flow length of the sample. The results are shown in Table 3. The sample having a longer spiral flow length means good flowability in molding.

Next, using the injection-molding machine, the pellets were molded into strips for evaluation of impact-resistant strength (Izod impact strength) and into dumbbells for evaluation of tensile strength (σy), and these were tested. The results are shown in Table 3.

The conditions in pelletization, in spiral flow length determination, and in molding into strips and dumbbells are mentioned below.

### <Condition in Pelletization>

Screw rotation speed: 30 rpm

### Cylinder Temperature:

Cylinder 1: 150° C.

Cylinder 2: 170° C.

Cylinder 3: 180° C.

Note: The cylinders are numbered in a order of 1, 2 and 3 from the material feeding side (hopper side) toward the extrusion direction, that is toward the screw tip.

### Head Temperature:

Die 1: 190° C.

Die 2: 190° C.

Note: The dies are numbered in a order of 1 and 2 from the screw tip toward the extrusion direction.

### <Spiral Flow Length Determination>

### Injection Unit Temperature:

Unit 1: 170° C.

Unit 2: 180° C.

Unit 3: 190° C.

Note: The units are numbered in a order of 1, 2 and 3 from the material feeding side (hopper side) toward the extrusion direction, that is toward the screw tip.
Nozzle temperature: 190° C.
Mold temperature: 40° C.
Injection speed: 50 mm/sec
Hold pressure: 1300 kg/cm²
Hold time: 3 sec
Injection pressure/hold pressure switching position: 2 mm
Maximum injection pressure: 1300 kg/cm²
Maximum injection time: 3 sec
Maximum hold pressure speed: 5 mm/sec
Back pressure: 100 kg/cm²
Screw rotation speed: 50 rpm
Cooling time: 20 sec
<Molding into Strips and Dumbbells>

### Injection Unit Temperature:

Unit 1: 170° C.

Unit 2: 180° C.

Unit 3: 190° C.

Note: The units are numbered in a order of 1, 2 and 3 from the material feeding side (hopper side) toward the extrusion direction, that is toward the screw tip.
Nozzle temperature: 190° C.
Mold temperature: 40° C.
Injection speed: 20 mm/sec
Hold pressure: 800 kg/cm²
Hold time: 5 sec
Injection pressure/hold pressure switching position: 5 mm
Maximum injection pressure: 1500 kg/cm²
Maximum injection time: 5 sec
Maximum hold pressure speed: 5 mm/sec
Back pressure: 100 kg/cm²
Screw rotation speed: 50 rpm
Cooling time: 20 sec

The content of the poly(n-butyl acrylate) macromonomer component in the composition was 0.1 part based on 100 parts of the poly(vinyl chloride) resin therein.

### Example 13

A vinyl chloride resin composition was produced in the same manner as in Example 12 except that 0.5 part of the poly(vinyl chloride)-graft-poly(n-butyl acrylate) resin C obtained in Preparation Example C was added, in place of the poly(vinyl chloride)-graft-poly(n-butyl acrylate) resin B obtained in Preparation Example B, to 100 parts of poly(vinyl chloride) resin. Also in the same manner as in Example 12, the composition was tested for the spiral flow length, the Izod impact strength and the value σy thereof. The results are shown in Table 3.

The content of the poly(n-butyl acrylate) macromonomer component in the composition was 0.1 part based on 100 parts of the poly(vinyl chloride) resin therein.

### Example 14

A vinyl chloride resin composition was produced in the same manner as in Example 13 except that 5 parts of the poly(vinyl chloride)-graft-poly(n-butyl acrylate) resin C was added to 100 parts of poly(vinyl chloride) resin. Also in the same manner as in Example 13, the composition was tested for the spiral flow length, the Izod impact strength and the value σy thereof. The results are shown in Table 3.

The content of the poly(n-butyl acrylate) macromonomer component in the composition was 1 part based on 100 parts of the poly(vinyl chloride) resin therein.

### Example 15

A vinyl chloride resin composition was produced in the same manner as in Example 12 except that 0.2 part of the poly(vinyl chloride)-graft-poly(n-butyl acrylate) resin D obtained in Preparation Example D was added, in place of the poly(vinyl chloride)-graft-poly(n-butyl acrylate) resin B obtained in Preparation Example B, to 100 parts of poly(vinyl chloride) resin. Also in the same manner as in Example 12, the composition was tested for the spiral flow length, the Izod impact strength and the value σy thereof. The results are shown in Table 3.

The content of the poly(n-butyl acrylate) macromonomer component in the composition was 0.1 part based on 100 parts of the poly(vinyl chloride) resin therein.

### Example 16

A vinyl chloride resin composition was produced in the same manner as in Example 15 except that 2 parts of the poly(vinyl chloride)-graft-poly(n-butyl acrylate) resin D was added to 100 parts of poly(vinyl chloride) resin. Also in the same manner as in Example 15, the composition was tested for the spiral flow length, the Izod impact strength and the value σy thereof. The results are shown in Table 3.

The content of the poly(n-butyl acrylate) macromonomer component in the composition was 1 part based on 100 parts of the poly(vinyl chloride) resin therein.

### Comparative Example 15

A vinyl chloride resin composition was produced in the same manner as in Example 12, to which, however, the poly(vinyl chloride)-graft-poly(n-butyl acrylate) resin B obtained in Preparation Example B was not added. Also in the same manner as in Example 12, the composition was tested for the spiral flow length, the Izod impact strength and the value σy thereof. The results are shown in Table 3. Unfavorably, the spiral flow length, the Izod impact strength and the value σy of the samples were all lower than those of the samples of Examples 12 to 16.

### Comparative Example 16

A vinyl chloride resin composition was produced in the same manner as in Comparative Example 15, to which, however, 3 parts of an impact modifier (Mitsubishi Rayon's Metablen C-323A, MBS resin) was added. Also in the same manner as in Comparative Example 15, the composition was tested for the spiral flow length, the Izod impact strength and the value σy thereof. The results are shown in Table 3. The spiral flow length and the value σy of the samples were both lower than those of the samples of Examples 12 to 16. This means that the effect of the impact modifier used herein was unsatisfactory.

### Comparative Example 17

A vinyl chloride resin composition was produced in the same manner as in Comparative Example 16, to which, however, 3 parts of CPE (Daiso's Daisolac H-135) was added in place of the impact modifier. Also in the same manner as in Comparative Example 16, the composition was tested for the spiral flow length, the Izod impact strength and the value σy thereof. The results are shown in Table 3. The spiral flow length and the value σy of the samples were both lower than those of the samples of Examples 12 to 16. This means that the effect of the additive used herein was unsatisfactory.

### Comparative Example 18

A vinyl chloride resin composition was produced in the same manner as in Comparative Example 16, to which, however, 5 parts of a plasticizer di-2-ethylhexyl phthalate (J-plus's DOP hereinafter referred to as DOP) was added in place of the impact modifier. Also in the same manner as in Comparative Example 16, the composition was tested for the spiral flow length, the Izod impact strength and the value σy thereof. The results are shown in Table 3. The Izod impact strength and the value σy of the samples were both lower than those of the samples of Examples 12 to 16. This means that the effect of the plasticizer used herein was unsatisfactory.

### Comparative Example 19

A vinyl chloride resin composition was produced in the same manner as in Comparative Example 16, to which, however, 1 part of a methyl methacrylate-type processing aid (Mitsubishi Rayon's Metablen P-551A) was added in place of the impact modifier. Also in the same manner as in Comparative Example 16, the composition was tested for the spiral flow length, the Izod impact strength and the value σy thereof. The results are shown in Table 3. The spiral flow length and the value σy of the samples were both lower than those of the samples of Examples 12 to 16. This means that the effect of the processing aid used herein was unsatisfactory.

### Comparative Example 20

A vinyl chloride resin composition was produced in the same manner as in Example 12 except that 1 part of the poly(vinyl chloride)-graft-poly(n-butyl acrylate) resin B obtained in Preparation Example B was added to 100 parts of poly(vinyl chloride) resin. Also in the same manner as in Example 12, the composition was tested for the spiral flow length, the Izod impact strength and the value σy thereof. The results are shown in Table 3. The spiral flow length, the Izod impact strength and the value σy of the samples were all lower than those of the samples of Examples 12 to 16, and were almost on the same level as that of the samples of Comparative Example 15. This means that the composition was ineffective.

The content of the poly(n-butyl acrylate) macromonomer component in the composition was 0.05 part based on 100 parts of the poly(vinyl chloride) resin therein.

### Comparative Example 21

A vinyl chloride resin composition was produced in the same manner as in Example 15 except that 3 parts of the poly(vinyl chloride)-graft-poly(n-butyl acrylate) resin D obtained in Preparation Example D was added to 100 parts of poly(vinyl chloride) resin. Also in the same manner as in Example 15, the composition was tested for the spiral flow length, the Izod impact strength and the value σy thereof. The results are shown in Table 3. The Izod impact strength and the value σy of the samples were both lower than those of the samples of Examples 12 to 16. This means that the composition was ineffective.

The content of the poly(n-butyl acrylate) macromonomer component in the composition was 1.5 parts based on 100 parts of the poly(vinyl chloride) resin therein.

TABLE 3

| | | Partial content of | Amount of vinyl | Content of | Additives other than vinyl | | | |
|---|---|---|---|---|---|---|---|---|
| | | macromonomer | chloride copolymer | macromonomer | chloride resin, vinyl | | | |
| | | component in the | resin added to 100 | component based on | chloride copolymer resin, | Spiral | Izod | |
| | | entire vinyl chloride | parts by weight of | 100 parts by weight of | thermal stabilizer and | flow | impact | |
| | | copolymer resin | vinyl chloride resin | vinyl chloride resin | lubricant, | length | strength | σy |
| | | (% by weight): X | (part by weight): Y | (part by weight): Z*¹⁾ | and their amount | (mm) | (kJ/m²) | (MPa) |
| Ex. | 12 | 5 | 2 | 0.1 | no | 435 | 3.3 | 50.7 |
| | 13 | 20 | 0.5 | 0.1 | no | 430 | 3.2 | 50.8 |
| | 14 | 20 | 5 | 1 | no | 460 | 3.4 | 51.3 |
| | 15 | 50 | 0.2 | 0.1 | no | 425 | 3.3 | 51.0 |
| | 16 | 50 | 2 | 1 | no | 455 | 3.5 | 50.9 |
| Com. | 15 | — | 0 | 0 | no | 400 | 3.1 | 50.6 |
| Ex. | 16 | — | 0 | 0 | MBS resin | 385 | 5.0 | 47.8 |
| | | | | | 3 parts by weight | | | |
| | 17 | — | 0 | 0 | CPE | 415 | 3.1 | 48.1 |
| | | | | | 3 parts by weight | | | |
| | 18 | — | 0 | 0 | DOP | 425 | 2.7 | 40.0 |
| | | | | | 5 parts by weight | | | |
| | 19 | — | 0 | 0 | Processing aid*²⁾ | 415 | 3.3 | 46.0 |
| | | | | | 1 part by weight | | | |
| | 20 | 5 | 1 | 0.05 | no | 400 | 3.2 | 50.0 |
| | 21 | 50 | 3 | 1.5 | no | 470 | 2.5 | 45.2 |

*¹⁾When poly(vinyl chloride)-graft-poly(n-butyl acrylate) resin is added to poly(vinyl chloride) resin, the value is calculated according to the following formula: Z = X × Y + 100
wherein Z indicates the content of the macromonomer component based on 100 parts by weight of the vinyl chloride resin (part by weight);
X indicates the partial content of the macromonomer component in the entire vinyl chloride copolymer resin (% by weight); and
Y indicates the amount of the vinyl chloride copolymer resin added to 100 parts by weight of the vinyl chloride resin (part by weight).
*²⁾Processing aid: methyl methacrylate processing aid.

### Example 17

100 parts of an ordinary poly(vinyl chloride) resin (KANEKA CORPORATION's KANEVINYL S1001, a vinyl chloride homopolymer resin having a K value of 68), 1.0 part of an organic tin thermal stabilizer (Katsuta Kako's TM694, methyltin mercaptide), 0.5 part of a special fatty acid ester lubricant (Riken Vitamin's Rikester SL-02), 0.3 part of polyethylene lubricant (Mitsui Chemical's Hiwax 220 MP), 0.2 part of a paraffin lubricant (Nippon Seiro's H-155), and 3.0 parts of a filler (Shiraishi Industry's Hakuenka CCR, calcium carbonate) were mixed in a Henschel mixer so that the resin temperature become 110° C., and then cooled to 50° C. or lower. The poly(vinyl chloride)-graft-poly(n-butyl acrylate) resin B obtained in Preparation Example B was added thereto in an amount of 2 parts relative to 100 parts of the poly(vinyl chloride) resin, thereby to obtain a vinyl chloride resin composition. The composition was fed into a conical extruder (Toshiba's TEC/55DV) and molded into 75φ pipes (inner diameter 75 mm, wall thickness 5 mm). Test pieces were cut out of the pipes, and tested for the impact-resistant strength (Izod impact strength) and the fracture toughness strength (slope value) thereof. The results are shown in Table 4.

The fracture toughness strength was determined according to the method mentioned in the following; the apparent Jc and slope values are determined according to the “Fracture Characterization of Tough Polymers Using the J method” described in S. Hashemi and J. G. Williams' Polymer Eng. and Sci., 26, 760 (1986).

Specifically, the crack length Δa is obtained from the sample thickness and the crack area, and the energy (kJ/m²) then applied to the crack and Δa are plotted to give a linear line. The value with Δa=0 on the line is an apparent Jc, which indicates the energy necessary for initiating new cracks to be generated. The linear line inclination (slope value) represents the energy necessary for promoting the cracks. Both these values reflect the fracture toughness of the sample. In this Example, the slope value is especially employed to indicate the fracture toughness strength of the sample. The sample having a larger slope value requires a larger quantity of energy for promoting cracks. Accordingly, the sample having a larger slope value has a higher fracture toughness strength.

The condition in forming pipes is mentioned below.

Screw rotation speed: 15 rpm
Feeder rotation speed: 10 rpm

### Cylinder Temperature:

Cylinder 1: 180° C.

Cylinder 2: 180° C.

Cylinder 3: 175° C.

Cylinder 4: 175° C.

Note: The cylinders are numbered in a order of 1, 2, 3 and 4 from the material feeding side (hopper side) toward the extrusion direction, that is toward the screw tip.

### Head Temperature:

Die 1: 170° C.

Die 2: 180° C.

Die 3: 185° C.

Die 4: 195° C.

Die 5: 200° C.

Note: The dies are numbered in a order of 1, 2, 3, 4 and 5 from the screw tip toward the extrusion direction.

The content of the poly(n-butyl acrylate) macromonomer component in the composition was 0.1 part based on 100 parts of the poly(vinyl chloride) resin therein.

### Example 18

A vinyl chloride resin composition was produced in the same manner as in Example 17 except that 0.5 part of the poly(vinyl chloride)-graft-poly(n-butyl acrylate) resin C obtained in Preparation Example C was added, in place of the poly(vinyl chloride)-graft-poly(n-butyl acrylate) resin B obtained in Preparation Example B, to 100 parts of poly(vinyl chloride) resin. Also in the same manner as in Example 17, the composition was shaped and cut, and tested for the Izod impact strength and the slope value thereof. The results are shown in Table 4.

The content of the poly(n-butyl acrylate) macromonomer component in the composition was 0.1 part based on 100 parts of the poly(vinyl chloride) resin therein.

### Example 19

A vinyl chloride resin composition was produced in the same manner as in Example 18 except that 5 parts of the poly(vinyl chloride)-graft-poly(n-butyl acrylate) resin C was added to 100 parts of poly(vinyl chloride) resin. Also in the same manner as in Example 18, the composition was shaped and cut, and tested for the Izod impact strength and the slope value thereof. The results are shown in Table 4.

The content of the poly(n-butyl acrylate) macromonomer component in the composition was 1 part based on 100 parts of the poly(vinyl chloride) resin therein.

### Example 20

A vinyl chloride resin composition was produced in the same manner as in Example 17 except that 0.2 part of the poly(vinyl chloride)-graft-poly(n-butyl acrylate) resin D obtained in Preparation Example D was added, in place of the poly(vinyl chloride)-graft-poly(n-butyl acrylate) resin B obtained in Preparation Example B, to 100 parts of poly(vinyl chloride) resin. Also in the same manner as in Example 17, the composition was shaped and cut, and tested for the Izod impact strength and the slope value thereof. The results are shown in Table 4.

The content of the poly(n-butyl acrylate) macromonomer component in the composition was 0.1 part based on 100 parts of the poly(vinyl chloride) resin therein.

### Example 21

A vinyl chloride resin composition was produced in the same manner as in Example 20 except that 10 parts of the poly(vinyl chloride)-graft-poly(n-butyl acrylate) resin D was added to 100 parts of poly(vinyl chloride) resin. Also in the same manner as in Example 20, the composition was shaped and cut, and tested for the Izod impact strength and the slope value thereof. The results are shown in Table 4.

The content of the poly(n-butyl acrylate) macromonomer component in the composition was 5 parts based on 100 parts of the poly(vinyl chloride) resin therein.

### Comparative Example 22

A vinyl chloride resin composition was produced in the same manner as in Example 17, to which, however, the poly(vinyl chloride)-graft-poly(n-butyl acrylate) resin B obtained in Preparation Example B was not added. Also in the same manner as in Example 17, the composition was shaped and cut, and tested for the Izod impact strength and the slope value thereof. The results are shown in Table 4. Unfavorably, the Izod impact strength and the slope value of the samples were both lower than those of the samples of Examples 17 to 21.

### Comparative Example 23

A vinyl chloride resin composition was produced in the same manner as in Comparative Example 22, to which, however, 3 parts of an impact modifier (Mitsubishi Rayon's Metablen C-323A, MBS resin) was added. Also in the same manner as in Comparative Example 22, the composition was shaped and cut, and tested for the Izod impact strength and the slope value thereof. The results are shown in Table 4. The slope value of the samples was lower than that of the samples of Examples 17 to 21. This means that the effect of the impact modifier used herein was unsatisfactory.

### Comparative Example 24

A vinyl chloride resin composition was produced in the same manner as in Comparative Example 23, to which, however, 6 parts of the impact modifier was added. Also in the same manner as in Comparative Example 23, the composition was shaped and cut, and tested for the Izod impact strength and the slope value thereof. The results are shown in Table 4. The slope value of the samples was lower than that of the samples of Examples 17 to 21. This means that the effect of the impact modifier used herein was still unsatisfactory.

### Comparative Example 25

A vinyl chloride resin composition was produced in the same manner as in Example 17 except that 1 part by weight of the poly(vinyl chloride)-graft-poly(n-butyl acrylate) resin B obtained in Preparation Example B was added to 100 parts of poly(vinyl chloride) resin. Also in the same manner as in Example 17, the composition was shaped and cut, and tested for the Izod impact strength and the slope value thereof. The results are shown in Table 4. The Izod impact strength and the slope value of the samples were both lower than those of the samples of Examples 17 to 21. This means that the composition was ineffective.

The content of the poly(n-butyl acrylate) macromonomer component in the composition was 0.05 part based on 100 parts of the poly(vinyl chloride) resin therein.

### Comparative Example 26

A vinyl chloride resin composition was produced in the same manner as in Example 18 except that 0.1 part of the poly(vinyl chloride)-graft-poly(n-butyl acrylate) resin C obtained in Preparation Example C was added to 100 parts of poly(vinyl chloride) resin. Also in the same manner as in Example 18, the composition was shaped and cut, and tested for the Izod impact strength and the slope value thereof. The results are shown in Table 4. The Izod impact strength and the slope value of the samples were both lower than those of the samples of Examples 17 to 21. This means that the composition was ineffective.

The content of the poly(n-butyl acrylate) macromonomer component in the composition was 0.02 part based on 100 parts of the poly(vinyl chloride) resin therein.

### Comparative Example 27

A vinyl chloride resin composition was produced in the same manner as in Example 18 except that 30 parts of the poly(vinyl chloride)-graft-poly(n-butyl acrylate) resin C obtained in Preparation Example C was added to 100 parts of poly(vinyl chloride) resin. Also in the same manner as in Example 18, the composition was shaped and cut, and tested for the Izod impact strength and the slope value thereof. The results are shown in Table 4. The Izod impact strength and the slope value of the samples were both lower than those of the samples of Examples 17 to 21. This means that the composition was ineffective.

The content of the poly(n-butyl acrylate) macromonomer component in the composition was 6 parts based on 100 parts of the poly(vinyl Chloride) resin therein.

### Comparative Example 28

A vinyl chloride resin composition was produced in the Same manner as in Example 20 except that 0.1 part of the poly(vinyl chloride)-graft-poly(n-butyl acrylate) resin D obtained in Preparation Example D was added to 100 parts of poly(vinyl chloride) resin. Also in the same manner as in Example 20, the composition was shaped and cut, and tested for the Izod impact strength and the slope value thereof. The results are shown in Table 4. The Izod impact strength and the slope value of the samples were both lower than those of the samples of Examples 17 to 21. This means that the composition was ineffective.

The content of the poly(n-butyl acrylate) macromonomer component in the composition was 0.05 part based on 100 parts of the poly(vinyl chloride) resin therein.

### Comparative Example 29

A vinyl chloride resin composition was produced in the same manner as in Example 20 except that 20 parts of the poly(vinyl chloride)-graft-poly(n-butyl acrylate) resin D obtained in Preparation Example D was added to 100 parts of poly(vinyl chloride) resin. Also in the same manner as in Example 20, the composition was shaped and cut, and tested for the Izod impact strength and the slope value thereof. The results are shown in Table 4. The Izod impact strength and the slope value of the samples were both lower than those of the samples of Examples 17 to 21. This means that the composition was ineffective.

The content of the poly(n-butyl acrylate) macromonomer component in the composition was 10 parts based on 100 parts of the poly(vinyl chloride) resin therein.

TABLE 4

| | | Partial content of | | Content of | | | | |
|---|---|---|---|---|---|---|---|---|
| | | macromonomer | Amount of vinyl chloride | macromonomer | | | | |
| | | component in the | copolymer resin added to | component based on 100 | Amount of | Izod impact | | |
| | | entire vinyl chloride | 100 parts by weight of | parts by weight of vinyl | impact modifier | strength | | |
| | | copolymer resin | vinyl chloride resin | chloride resin | (part by | kJ/cm² | | Slope |
| | | (% by weight): X | (part by weight): Y | (part by weight): Z*¹⁾ | weight)*²⁾ | 0° C. | 23° C. | value |
| Ex. | 17 | 5 | 2 | 0.1 | 0 | 6.8 | 10.8 | 28.8 |
| | 18 | 20 | 0.5 | 0.1 | 0 | 6.5 | 10.3 | 26.7 |
| | 19 | 20 | 5 | 1 | 0 | 7.3 | 11.1 | 30.5 |
| | 20 | 50 | 0.2 | 0.1 | 0 | 6.0 | 9.7 | 25.0 |
| | 21 | 50 | 10 | 5 | 0 | 5.9 | 9.2 | 33.8 |
| Com. | 22 | — | 0 | 0 | 0 | 3.0 | 3.7 | 18.8 |
| Ex. | 23 | — | 0 | 0 | 3 | 7.5 | 9.2 | 20.3 |
| | 24 | — | 0 | 0 | 6 | 10.5 | 13.7 | 21.9 |
| | 25 | 5 | 1 | 0.05 | 0 | 3.3 | 4.0 | 19.8 |
| | 26 | 20 | 0.1 | 0.02 | 0 | 3.0 | 3.8 | 19.0 |
| | 27 | 20 | 30 | 6 | 0 | 3.7 | 6.6 | 21.8 |
| | 28 | 50 | 0.1 | 0.05 | 0 | 3.1 | 3.5 | 19.3 |
| | 29 | 50 | 20 | 10 | 0 | 4.0 | 7.5 | 22.2 |

*¹⁾When poly(vinyl chloride)-graft-poly(n-butyl acrylate) resin is added to poly(vinyl chloride) resin, the value is calculated according to the following formula: Z = X × Y + 100
wherein Z indicates the content of the macromonomer component based on 100 parts by weight of the vinyl chloride resin (part by weight);
X indicates the partial content of the macromonomer component in the entire vinyl chloride copolymer resin (% by weight); and
Y indicates the amount of the vinyl chloride copolymer resin added to 100 parts by weight of the vinyl chloride resin (part by weight).
*²⁾Impact modifier: MBS resin

### INDUSTRIAL APPLICABILITY

The vinyl chloride resin composition of the present invention is shaped into various products, for example, calendered articles such as blister packs, leather products, polyvinyl films for agricultural use, shrink films and various sheets; laminate films for substrates such as poly(vinyl chloride)-steel sheets; substrates for laminates such as laminate press sheets; injection-molded articles such as joints and valves; extrusion-molded articles such as pipes, flat plates, waved plates, films, tapes, sheets, foam boards or sheets, window frames and other various profiles; blow-molded articles such as bottles, duct boots, bellows; vacuum-formed articles such as toys, signboards, masks and press mats.

1. A vinyl chloride resin composition, which is prepared by adding a vinyl chloride copolymer resin obtained by copolymerizing a vinyl monomer and a macromonomer having a polymer comprising an ethylenically unsaturated monomer containing a double bond in a main chain, to a vinyl chloride resin.

2. The vinyl chloride resin composition of claim 1, wherein the content of the macromonomer component based on 100 parts by weight of the vinyl chloride resin is 0.1 to 5 parts by weight.

3. The vinyl chloride resin composition of claim 1, wherein the macromonomer component in the vinyl chloride copolymer resin is 3 to 50% by weight.

4. A molded article comprising the vinyl chloride resin composition of claim 1.

5. The molded article of claim 4, which is obtained by calendering.

6. The molded article of claim 4, which is obtained by injection-molding.

7. The molded article of claim 4, which is obtained by extrusion-molding.
